(19) United States
(12) Patent Application Publication
(10) Pub. No.: US 2011/0246887 A1
(43) Pub. Date: Oct. 6, 2011

(54) Infotainment System

(75) Inventor: Wolfgang Weichenrieder, Abensberg (DE)

(73) Assignee: Continental Automotive GmbH, Hannover (DE)

(21) Appl. No.: 13/139,466

(22) PCT Filed: Dec. 9, 2009
(86) PCT No.: PCT/EP09/66766

§ 371 Date: Jun. 13, 2011

(30) Foreign Application Priority Data
Dec. 11, 2008 (DE) 10 2008 061 574.9

(51) Int. Cl. G06F 3/048

(52) U.S. Cl. 715/716

(57) ABSTRACT

An infotainment system includes a display device, a freely accessible data transfer interface for a user of the infotainment system, a computing unit, a first memory and a user interface with an input unit and a graphical operating interface. The infotainment system is adapted to store predefined user configuration data in the first memory. The user configuration data is representative for a graphical display of the graphical operating interface by the control unit. The infotainment system is also adapted to interpret the predefined user configuration data such that the graphical operating interface represented by the user configuration data can be displayed using the display device and/or such that the manual operation of the user interface represented by the user configuration data can be predefined using the input unit.

### PRIORITY CLAIM

This is a U.S. national stage of Application No. PCT/EP2009/066766, filed on Dec. 9, 2009, which claims priority to German Application No: 10 2008 061 574.9, filed: Dec. 11, 2008, the contents of which are incorporated herein by reference.

### BACKGROUND OF THE INVENTION

### Field of the Invention

The invention relates to an infotainment system having a display device, a computation unit, a first memory, and a user interface. The user interface has at least an associated input unit and an associated graphical user interface.

Modern motor vehicles routinely have operator controls with a display and an input unit. These involve a plurality of functions, for example functions of an infotainment system, being combined in the operator control unit and the associated display. Depending on the activated menu item, the operator control unit, for example a rotary control, adopt the associated switching behavior for each operator control task. The effect of this is to prevent the threat of excessive demand on the driver (see “Vieweg-Handbuch Kraftfahrzeugtechnik” [Vieweg Manual of Motor Vehicle Engineering], Braess/Seiffert, 4th edition, Vieweg publishers, page 638).

### SUMMARY OF THE INVENTION

It is an object of one embodiment of the invention to specify an infotainment system which allows particularly simple and reliable configuration.

One embodiment of the invention is an infotainment system that has a display device, a data transmission interface which is freely accessible to a user of the infotainment system, a computation unit, a first memory and a user interface. The user interface has at least an associated input unit and an associated graphical user interface. The infotainment system is designed to store prescribed user configuration data provided by the freely accessible data transmission interface in the first memory. The user configuration data is representative of a graphical representation of the graphical user interface and/or of handling of the user interface by the at least one operator control unit. In addition, the infotainment system is designed to interpret the prescribed user configuration data in such a way, by the computation unit, that the graphical user interface represented by the user configuration data can be presented by the display device and/or that the handling of the user interface, as represented by the user configuration data, prescribed by the at least one input unit.

Both the graphical representation of the graphical user interface and/or the handling of the user interface can also be altered after the manufacture of the infotainment system by the prescribed user configuration data. In this case, the infotainment system has the freely accessible data transmission interface, which is also accessible to a user of the infotainment system rather than just to the manufacturer. Preferably, the infotainment system is arranged in a motor vehicle. The graphical user interface and the at least one input unit of the user interface are provided in order for the user to interact with the infotainment system. That is to say that these components can be used to activate or deactivate a functionality of the infotainment system that is prescribed by the user.

The user configuration data is preferably produced by the user of the infotainment system such that the graphical representation of the graphical user interface and/or the handling of the user interface meet(s) the requirements of the user and is/are not exclusively prescribed by the manufacturer of the infotainment system.

By way of example, the freely accessible data transmission interface is in the form of a universal serial bus interface (USB interface), wherein the user configuration data provided by means of the freely accessible data transmission interface are automatically recognized by the infotainment system as such and stored in the first memory.

In one embodiment the infotainment system has a second memory stores manufacturer configuration data. The manufacturer configuration data are produced and stored in the second memory during manufacture of the infotainment system.

The manufacturer configuration data is representative of the graphical representation of the graphical user interface and/or of handling of the user interface. The infotainment system is also designed to access the second memory and interpret the manufacturer configuration data if the user configuration data are erroneous. This helps to allow the configurable infotainment system to be operated particularly reliably. By way of example, the erroneous user configuration data can result from a defective data transmission to the first memory of the infotainment system and/or can actually be produced erroneously by the user of the infotainment system. Preferably, the second memory also stores further manufacturer-related data and/or programs, for example an operating system.

In principle, the first memory may also be in the form of a first memory area of a memory unit and the second memory may be in the form of a second memory area of the memory unit. Preferably, the first memory is in the form of a nonvolatile, reprogrammable memory or memory area. The second memory is preferably in the form of a nonvolatile, nonreprogrammable memory or memory area, for example in the form of a one-time-programmable memory area. In principle, it is alternatively possible for the second memory to be in the form of a nonvolatile, reprogrammable memory.

In one embodiment the second memory can be accessed only by a separate data transmission interface, that is inaccessible to the user. The separate data transmission interface is preferably in the form of an internal interface which is not freely accessible to the user of the infotainment system. Preferably, the second memory can be accessed only via this separate data transmission interface. By way of example, the separate data transmission interface can be accessed only by the manufacturer and/or a garage of the motor vehicle. This has the advantage that the manufacturer configuration data cannot be erased and/or reprogrammed by the user.

In a further advantageous refinement, the infotainment system is designed to take the user and manufacturer configuration data as a basis for prescribing the graphical representation of the graphical user interface and/or the handling of the user interface. This helps produce a particularly reliable form of the infotainment system. By way of example, the manufacturer configuration data is used to prescribe handling and/or graphical representation of a selection—prescribed by the manufacturer—of operationally relevant functions and/or data in the motor vehicle, for example a speed display, handling of chassis and/or damping settings, etc., while the user configuration data is used to prescribe handling and/or graphical representation of entertainment functions and/or data, for example a representation of a CD/radio operator control panel, etc., and/or other operationally relevant data in the motor vehicle, for example.

By way of example, the user configuration data can be produced by a method for configuring the user interface of the infotainment system. In this case, prescribed setting components, for example graphical setting components, are provided for the purpose of configuring the graphical representation of the graphical user interface and/or the handling of the user interface. Accordingly, the prescribed setting components are used to create a representation of the graphical user interface and/or a representation of the handling of the infotainment system. Preferably, the setting options, which can be prescribed by the prescribed setting components for the respective representation, are limited to a prescribed scope. Accordingly, the respective created representation is taken as a basis for producing the user configuration data which can be interpreted by the infotainment system.

Preferably, the graphical user interface has operator control elements, for example graphical operator control elements such as bit maps or graphical buttons, for each of which at least one functionality of the infotainment system is prescribed by the use of the prescribed setting components in the prescribed scope. In this context, the respective operator control element of the graphical user interface can be actuated by the at least one input unit.

The use of the prescribed setting components can be used to prescribe a position and/or a size and/or a color for at least one of the operator control elements in the prescribed limited scope. In addition, the use of the prescribed setting components can be used to prescribe a menu presentation, for example a menu hierarchy, in the prescribed scope, with which the respective operator control elements are associated. It is also possible for the use of the prescribed setting components to be used to prescribe a font and/or a font size and/or a background design for the graphical user interface.

A computer program which is produced on a computer-readable medium and comprises program instructions could be provided. The program instructions, which can be executed by a computer, allow the method for configuring the user interface of the infotainment system to be performed.

### BRIEF DESCRIPTION OF DRAWINGS

Exemplary embodiments of the invention are explained in more detail below with reference to the schematic drawings, in which:

FIG. 1 is an infotainment system ;and

FIG. 2 is a flowchart.

Elements having the same design or function are denoted by the same reference symbols across the figures.

### DETAILED DESCRIPTION OF DRAWINGS

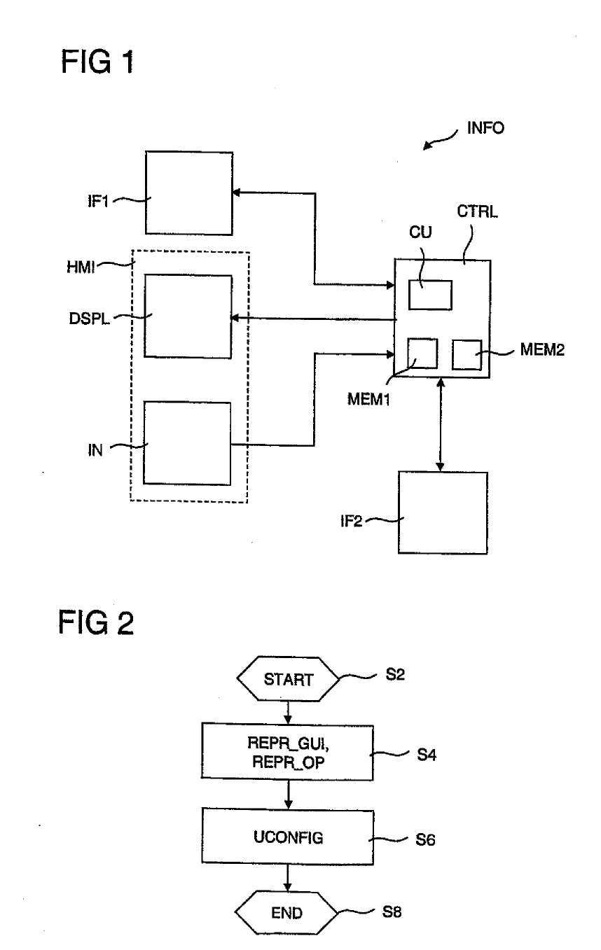

FIG. 1 shows an infotainment system INFO which is preferably arranged in a motor vehicle. By way of example, the infotainment system INFO comprises a navigation system and/or a radio and/or an onboard computer in the motor vehicle. In principle, it is possible for further components to be provided. Furthermore, the infotainment system INFO comprises a control unit CTRL which has a computation unit CU and a first and a second memory MEM1, MEM2. In addition, the infotainment system INFO comprises a display device DSPL, an input unit IN and a first and a second data transmission interface IF1, IF2. The display device DSPL and the input unit IN can be denoted as a user interface HMI of the infotainment system INFO. By way of example, the display device DSPL is in the form of a display, for example in the form of a head-up display or a head-down display, By way of example, the input unit IN comprises a rotary control and/or pushbuttons. The display device DSPL and the input unit IN may also be in the form of a physically cohesive unit, in the form of a touchscreen display. Alternatively, the input unit IN may also be in the form of a voice recognition unit and hence recognize and interpret voice commands from a driver of the motor vehicle. By way of example, the first data transmission interface IF1 is in the form of a universal serial bus interface (USB interface). The display device DSPL, the input unit IN and the first data transmission interface IF1 are arranged in a central console of the motor vehicle, for example. This means that the first data transmission interface IF1 is also freely accessible to a user of the motor vehicle. By contrast, the second data transmission interface IF2 is not freely accessible to the user of the infotainment system.

The control unit CTRL is electrically coupled to the first and second data transmission interfaces IF1, IF2, to the display device DSPL and to the input unit IN. The control unit CTRL is designed to interpret input data prescribed by the input unit IN, for example by a driver of the motor vehicle, and to actuate the display device DSPL on the basis of the input data IN. In this case, a graphical user interface associated with the user interface HMI is displayed by the display device DSPL. The control unit CTRL is also designed to read in data provided by the first data transmission interface IF1 and possibly to store them in the first memory MEMS. The first memory MEM1 is preferably in the form of a nonvolatile, programmable memory or memory area of a memory unit, for example in the form of EEPROM or flash memory.

Preferably, the second memory MEM2 stores manufacturer configuration data created and stored in the second memory MEM2 during manufacture of the infotainment system INFO. The second memory MEM2 is in the form of a nonvolatile, preferably in the form of a nonreprogrammable, memory, for example in the form of a read only memory (ROM memory). Alternatively, the second memory MEM2 may also be in the form of a second memory area, for example in the form of a one-time programmable memory area (OTP memory area), of the memory unit. In principle, the second memory MEM2 may alternatively be in the form of a programmable memory or memory area. The second memory MEM2 cannot be actuated via the first data transmission interface IF1, but rather can be actuated exclusively via the second data transmission interface IF2. The second data transmission interface IF2 is accessible only to the manufacturer of the infotainment system INFO or to a garage of the motor vehicle. In principle, the second memory MEM2 may also store further manufacturer-relevant data and/or programs, for example an operating system, which are accessible exclusively to the manufacturer.

The manufacturer configuration data can be interpreted by the computation unit CU. In this case, the manufacturer configuration data is taken as a basis for actuating the display device DSPL and the input unit IN. The manufacturer configuration data represent a graphical representation of the graphical user interface which is displayed by the display device DSPL, and/or handling of the infotainment system INFO, which can be prescribed by the input unit IN.

Preferably, the graphical user interface of the infotainment system INFO, which graphical user interface is displayed to the user of the motor vehicle by the display device DSPL, has a prescribed menu presentation that contains one or more operator control elements, particularly graphical operator control elements. The individual operator control elements can be actuated and activated or deactivated by the input unit IN. In this case, each operator control element has one or more respective associated functions of the infotainment system INFO. Thus, by way of example, an operator control element of the graphical user interface can be used to prescribe a volume for a radio and/or to select a seat level for the driver of the motor vehicle and/or a destination for a navigation system. By way of example, the respective operator control element may be in the form of a bit map graphic. Alternatively, the respective operator control element may also be in the form of a graphical pushbutton (button) or in the form of a selectable menu item in the menu presentation or in the form of a button.

The infotainment system INFO is designed to interpret not only the manufacturer configuration data, which is already stored in the second memory MEM2 before delivery and/or before installation of the infotainment system INFO in the respective motor vehicle, but also user configuration data UCONFIG (FIG. 2) by the computation unit CU. In a similar manner to the manufacturer configuration data, the user configuration data UCONFIG represent the graphical representation of the graphical user interface which is displayed by the display device DSPL, and/or the handling of the infotainment system INFO, which can be prescribed by the input unit IN.

The user configuration data UCONFIG can also be provided after the manufacture of the infotainment system INFO, for example after installation in the respective motor vehicle, by the respective driver or user of the motor vehicle by the first data transmission interface IF1. The control unit CTRL is designed to recognize and read in the user configuration data UCONFIG provided by means of the first data transmission interface IF1 and to store them in the first memory MEM1. By way of example, the user configuration data UCONFIG can be provided in the form of one or more files.

The control unit CTRL is designed to access the user configuration data UCONFIG stored in the first memory MEM1 and to take these as a basis for prescribing the graphical user interface and/or the handling of the operator control unit. If, on the other hand, no user configuration data or erroneous configuration data is present in the first memory MEM1, the control unit CTRL is designed to access the manufacturer configuration data and to take it as a basis for prescribing the graphical user interface and/or the handling of the operator control unit. Preferably, the control unit CTRL may also be designed to prescribe the graphical user interface and the handling of the operator control unit on the basis of user and manufacturer configuration data.

The user configuration data UCONFIG can be created by the user of the motor vehicle. To this end, it is possible to use a method for configuring the user interface HMI of the infotainment system INFO (see FIG. 2). By way of example, the method for configuring the user interface HMI can be performed using a program which can be executed by a data processing installation, for example a personal computer, and which allows the user configuration data UCONFIG to be configured and produced according to the requirements of the user.

The method is started in a step S2. In a step S4, a representation REPR_GUI of the graphical user interface and a representation REPR_OP of the handling of the user interface HMI are created. To this end, setting components are prescribed, for example by the program. The prescribed setting components are preferably in the form of software components of the program and are made available to the user. These can be used to alter and prescribe and hence shape a graphical representation of the graphical user interface. By way of example, the prescribed setting components can be used to create one or more operator control elements afresh or to alter the graphical representation of existing operator control elements. By way of example, the prescribed setting components can be used to prescribe a position and/or a size and/or a color for the operator control elements. In addition, it is possible to prescribe a menu presentation of the graphical user interface, for example a menu hierarchy, with which the created operator control elements are associated. In principle, it is also possible to prescribe a font and/or a font size for the text using the graphical user interface. It is also possible for a background design, for example a background color and/or a background image, to be prescribed by the prescribed setting components. It is also possible for the respective operator control element to be allocated one or more respective functions of the infotainment system INFO which can be activated or deactivated by means of the actuation of the respective operator control element. If a plurality of functions are associated with the respective operator control element, these functions can be performed in succession. The respective representation REPR_GUI, REPR_OP is created by the user of the program, for example by the driver of the motor vehicle.

The graphical user interface can be designed, and the handling of the infotainment system INFO can be prescribed, by the prescribed setting components only in a prescribed scope. Thus, the user has only limited options for prescribing settings for the graphical representation and handling of the user interface HMI. These limitations may result, by way of example, from the prescribed setting components being a particularly simple design to allow a simple design of the graphical representation of the graphical user interface and of the handling of the user interface HMI for the user. By way of example, it is thus possible to prescribe regions of the graphical user interface within which the created operator control elements can merely be positioned. In addition, by way of example, only prescribed functionalities can be prescribed for the respective operator control elements, for example entertainment functions and/or entertainment data such as CD/radio and/or navigation operator control functions and/or—data.

In a step S6, the created representations REPR_GUI, REPR_OP are taken as a basis for producing the user configuration data UCONFIG, for example in the form of one or more configuration files. This at least one configuration file can be copied and transported on a USB mass memory, for example. The USB mass memory can then easily be coupled to the first, freely accessible data transmission interface IF1 and hence made available to the infotainment system INFO.

In a step S8, the method for configuring the user interface HMI of the infotainment system INFO is terminated.

Various user configuration data UCONFIG can also be provided in the form of configuration files on the Internet, for example in the form of a charged or free download portal, for example for the purpose of interchange.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. An infotainment system comprising:
a display device;
a data transmission interface that is freely accessible to a user of the infotainment system;
a computation unit;
a first memory; and
a user interface having at least an associated input unit and an associated graphical user interface, wherein the infotainment system is configured to:
store prescribed user configuration data provided by the data transmission interface in the first memory, the user configuration data is representative of at least one of a graphical representation of the graphical user interface and of handling of the user interface by the at least one operator control unit, and
interpret the prescribed user configuration data by the computation unit such that the graphical user interface represented by the user configuration data is presented by one of the display device and the handling of the user interface, as represented by the user configuration data by the at least one input unit.

6. The infotainment system as claimed in claim 5, further comprising:
a second memory that stores manufacturer configuration data produced and stored during manufacture of the infotainment system,
wherein the manufacturer configuration data is representative of one of the graphical representation of the graphical user interface and of handling of the user interface, and
wherein the infotainment system is designed to access the second memory and to interpret the manufacturer configuration data if the user configuration data is erroneous.

7. The infotainment system as claimed in claim 6, wherein the second memory is configured to be accessed only by a separate data transmission interface that is inaccessible to the user.

8. The infotainment system as claimed in claim 6, configured to take the user and the manufacturer configuration data as a basis for prescribing one of the graphical representation of the graphical user interface and the handling of the user interface.

9. The infotainment system as claimed in claim 7, configured to take the user and the manufacturer configuration data as a basis for prescribing one of the graphical representation of the graphical user interface and the handling of the user interface.

10. A method for configuring a user interface of an infotainment system using a program executed by a data processing installation that allows user configuration data to be configured, comprising:
creating a representation of the graphical user interface;
creating a representation of a handling of the user interface;
producing the user configuration based at least in part on the representation of the graphical user interface and the representation of a handling of the user interface; and
storing the user configuration in a memory.

11. The method of claim 10, further comprising prescribing a menu presentation of the graphical user interface with which operator control elements are associated.
